(19) United States
(12) Patent Application Publication
(10) Pub. No.: US 2015/0184445 A1
(43) Pub. Date: Jul. 2, 2015

(54) GUIDE RAIL AND ROLLER SHUTTER STRUCTURE AND ROLLER SHUTTER TYPE BOX USING THE SAME

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: WEN-HSING LIN, New Taipei (TW); LIANG-FENG ZHANG, Shenzhen (CN); XIONG CHEN, Shenzhen (CN); QIANG ZHANG, Shenzhen (CN)

(21) Appl. No.: 14/523,485

(22) Filed: Oct. 24, 2014

(30) Foreign Application Priority Data
Dec. 31, 2013 (CN) 201310744812.2

(51) Int. Cl. E06B 3/46; E05D 15/06

(52) U.S. Cl. CPC E06B 3/46; E05D 15/0608

(57) ABSTRACT

A guide rail and roller shutter structure includes a first supporting member, a second supporting member, and a roller shutter slidably mounted between the first supporting member and the second supporting member. The first supporting member includes a first sliding path, and the second supporting member includes a second sliding path. The roller shutter includes a sliding body, a plurality of first extending portions, and a plurality of second extending portions. Each extending portion includes a first contact portion and a second contact portion protruding from two opposing surfaces of the extending portion. The first contact portions and second contact portions slidably contact the first and second sliding paths allowing the roller shutter to slide along the first and second sliding paths. A roller shutter type box including the guide rail and roller shutter structure is also provided.

### FIELD

The subject matter herein generally relates to a guide rail and roller shutter structure and a roller shutter type box using the same.

### BACKGROUND

A conventional roller shutter type box includes a container, a pair of guide grooves, and a roller shutter. The container has an upper opening. Objects or items may be placed in or removed from the container through the opening. The guide grooves are formed on both sides of the container. The opening is selectively opened and closed by sliding the roller shutter in the guide grooves.

### BRIEF DESCRIPTION OF THE DRAWINGS

Implementations of the present technology will now be described, by way of example only, with reference to the attached figures.

FIG. 1 is an isometric view of an embodiment of a roller shutter type box.

FIG. 2 is an exploded, isometric view of the roller shutter type box of FIG. 1.

FIG. 3 is an enlarged view of a portion III of the roller shutter type box of FIG. 2.

FIG. 4 is an isometric view of a roller shutter of the roller shutter type box shown in FIG. 1.

FIG. 5 is a cross-sectional view of the roller shutter type box taken along a line V-V of FIG. 1.

FIG. 6 is an enlarged view of a portion VI of the roller shutter type box of FIG. 5.

FIG. 7 is a cross-sectional view of the roller shutter type box taken along a line VII-VII of FIG. 1.

FIG. 8 is an enlarged view of a portion VIII of the roller shutter type box of FIG. 7.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “substantially” is defined to be essentially conforming to the particular dimension, shape or other feature that is modified by the word “substantially”, such that the feature of the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

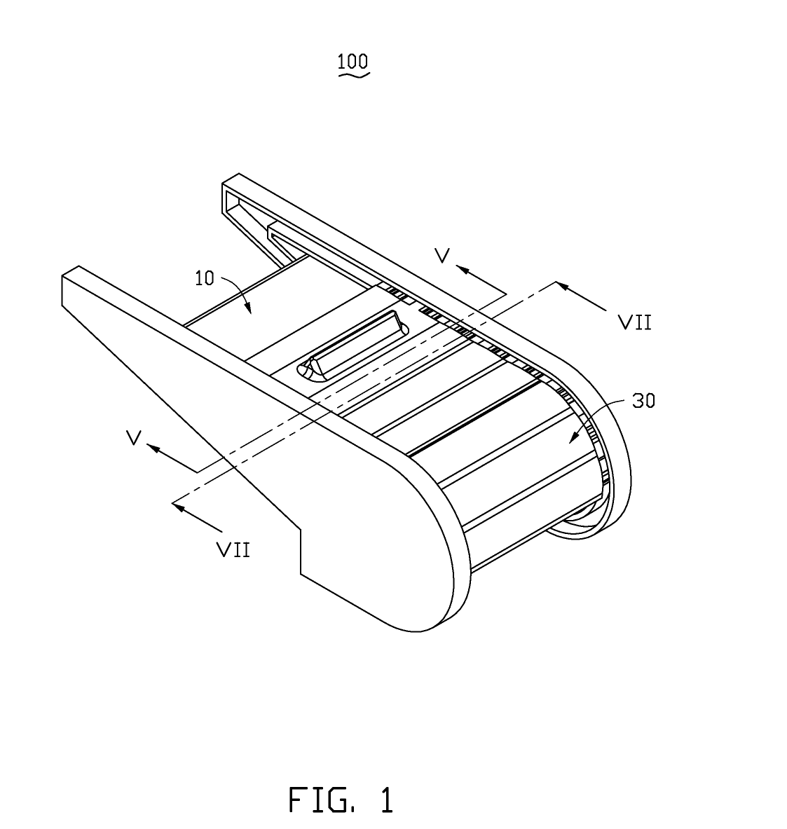

FIG. 1 illustrates a roller shutter type box 100 including a container 10 and a sliding rail structure 30 positioned on the container 10. The sliding rail structure 30 can slide on the container 10 for opening and closing the container 10.

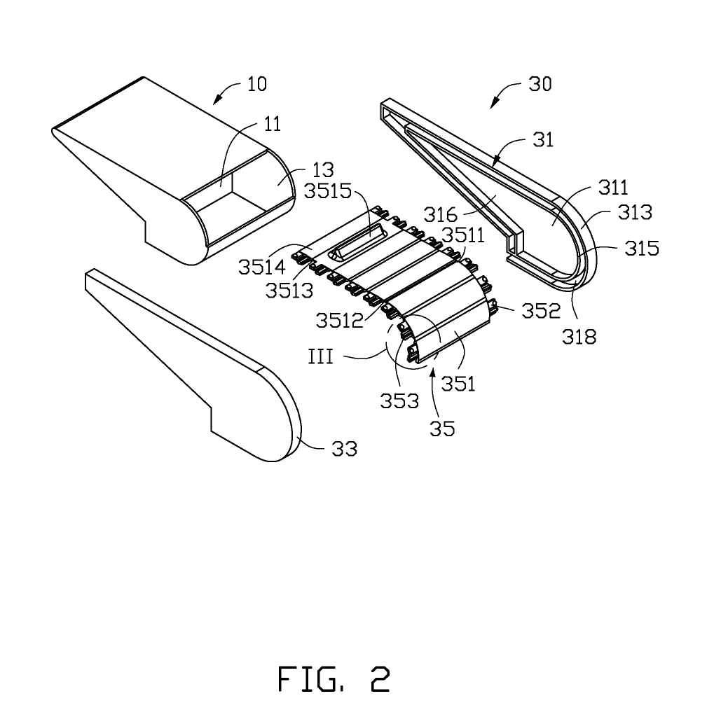

FIG. 2 illustrates that the container 10 can define a receiving portion 11 and an opening 13 in fluid communication with the receiving portion 11. Objects or items can be placed in or removed from the receiving portion 11 through the opening 13.

The sliding rail structure 30 can include a first supporting member 31, a second supporting member 33, and a roller shutter 35 slidably positioned between the first supporting member 31 and the second supporting member 33. In at least one embodiment, the first supporting member 31 and the second supporting member 33 can be shuttle plates. The first supporting member 31 can be a first side plate, and the second supporting member 33 can be a second side plate.

The first supporting member 31 can include a supporting body 311, a first supporting wall 313, and a second supporting wall 315. The first supporting wall 313 can be opposite to and substantially parallel with the first supporting wall 315. The first supporting wall 313 and the second supporting wall 315 can be positioned around an periphery of the supporting body 311 and opposite to each other. In at least one embodiment, the supporting body 311 can be a substantially shuttle plate. The first supporting wall 313 can be a rib vertically projecting from the periphery of the supporting body 311. The second supporting wall 315 can be a rib adjacent to the first supporting wall 313 and vertically projecting from the supporting body 311. The second supporting wall 315 and the supporting body 311 can cooperatively define a chamber 316. The first supporting wall 313, the second supporting wall 315, and the supporting body 311 can cooperatively form a first sliding path 318. The first sliding path 318 can be annular with one end open and the other end closed. In other embodiments, the supporting body 311 can be omitted, and the first supporting wall 313 and the second supporting wall 315 can be positioned opposite to each other and cooperatively form the first sliding path 318 therebetween.

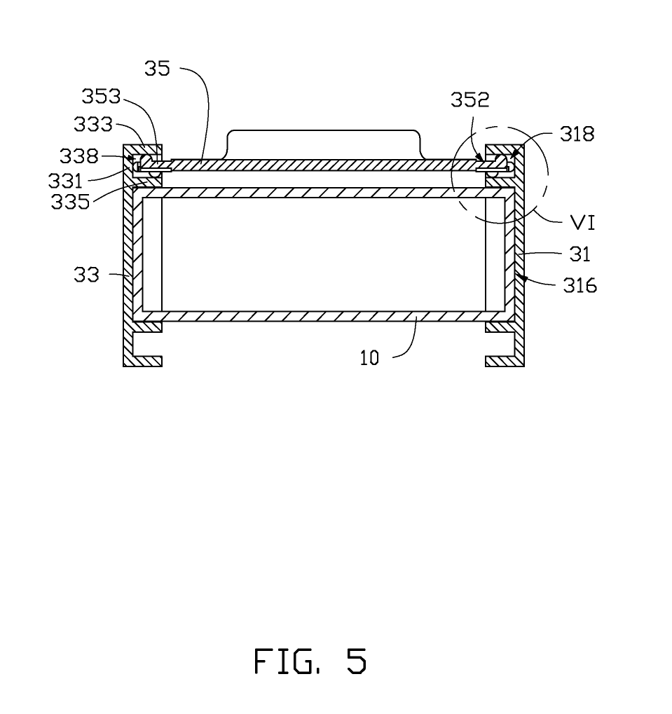

The second supporting member 33 can have a substantially same shape as the first supporting member 31 and include a second sliding path 338 opposite the first sliding path 318 (shown in FIG. 5).

The roller shutter 35 can cover the opening 13 of the container 10, and two ends of the roller shutter 35 can be slidably received in the first sliding paths 318 and the second sliding path 338. The roller shutter 35 can include a sliding body 351 with a first side end 3511 and a second side end 3512 and a plurality of first extending portions 352 extending from the first side end 3511 of the sliding body 351 and a plurality of second extending portions 353 extending from the second side end 3512 of the sliding body 351.

The sliding body 351 can be a substantially rectangular plate, and a surface of the sliding body 351 toward the container 10 can define a plurality of strip grooves 3513, thus the sliding body 351 can be divided into a plurality of connecting portions 3514 by the strip grooves 3513. The connecting portions 3514 can be connected sequentially. The connecting portions 3514 can be strip shaped and extend along a direction substantially perpendicular to the first sliding path 318. The sliding body 351 can bend at the grooves 3511, such that the sliding body 351 can bend to accommodate to the first sliding path 318.

The first extending portions 352 and the second extending portions 353 can be evenly spaced at two sides of the sliding body 351 and made of an elastic material. The roller shutter 35 can further include a holding portion 3515 protruding from one connecting portion 3514, and the holding portion 3515 can be used to pull the roller shutter 35. The first extending portion 352 can be substantially same as the second extending portion 353.

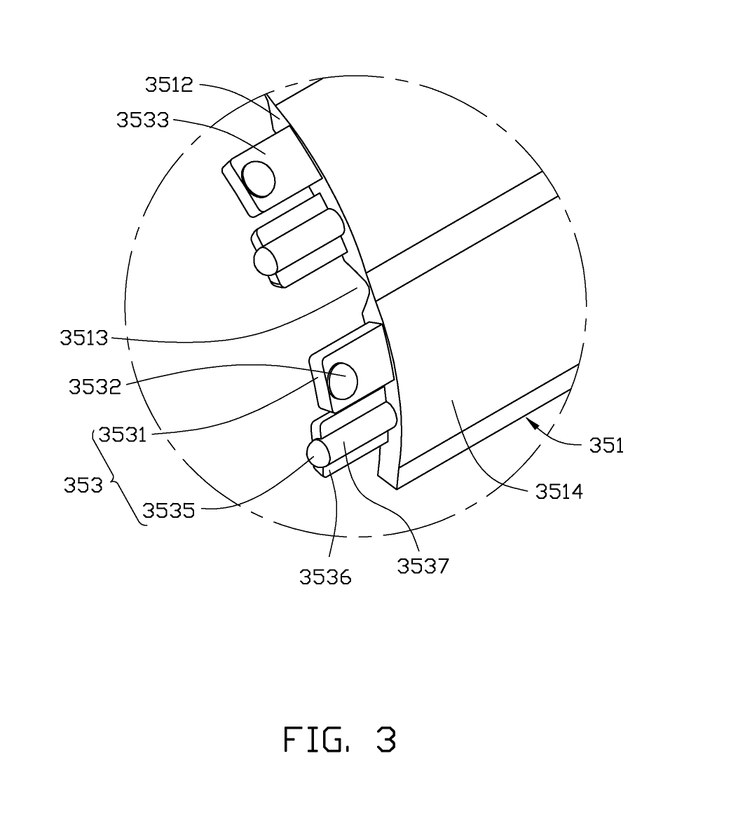

FIG. 3 illustrates that each second extending portion 353 can be positioned at one end of the connecting portion 3514. Each second extending portion 353 can have a first surface 3533 substantially perpendicular to the second side end 3512 of the roller shutter sliding body 351. The second extending portion 353 can include a first extending arm 3531 and a second extending arm 3535. The first extending arm 3531 and the second extending arm 3535 can be positioned distanced from each other. The first extending arm 3531 can be a substantially rectangular plate, and include a first contact portion 3532 protruding out of the first surface 3533. In at least one embodiment, the first contact portion 3532 can be hemispheric.

The second extending arm 3535 can include a base 3536 and a convex shaft 3537. The base 3536 can be a substantially rectangular plate. The convex shaft 3537 can protrude out of the base 3536 and extend along a direction substantially vertical to the first sliding path 318. The convex shaft 3537 can be distanced from the first supporting wall 313 (shown in FIG. 2)

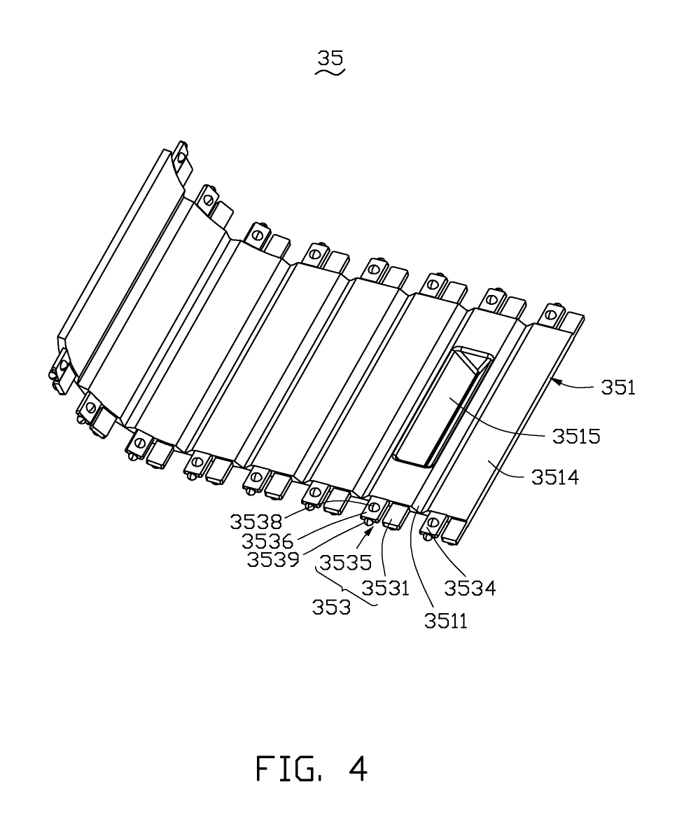

FIG. 4 illustrates that the second extending arm 3535 can further include a second contact portion 3538 and a third contact portion 3539. Each second extending portion 353 can further have a second surface 3534 substantially perpendicular to the second side end 3512 of the roller shutter sliding body 351. The second extending portion first surface 3533 can be opposite to and substantially parallel with the second extending portion second surface 3534.

The second contact portion 3538 can protrude out of the second extending portion second surface 3534. The third contact portion 3539 can protrude out of an end surface of the convex shaft 3537 (shown in FIG. 3). In at least one embodiment, the second contact portion 3538 and the third contact portion 3539 can be hemispheric.

FIG. 5 illustrates that the second supporting member 33 can be positioned opposite to the first supporting member 31, and has a substantially same shape as the first supporting member 31. The second supporting member 33 can include a second supporting member 331, a first supporting wall 333, and a second supporting wall 335. The second supporting member 33 can define a chamber (not labeled) corresponding to the chamber 316. Two side walls (not labeled) of the container 10 can be received in the two chambers of the first supporting member 31 and the second supporting member 33. The first extending portions 352 can be slidably received in the first sliding path 318, and the second extending portions 353 can be slidably received in the second sliding path 338.

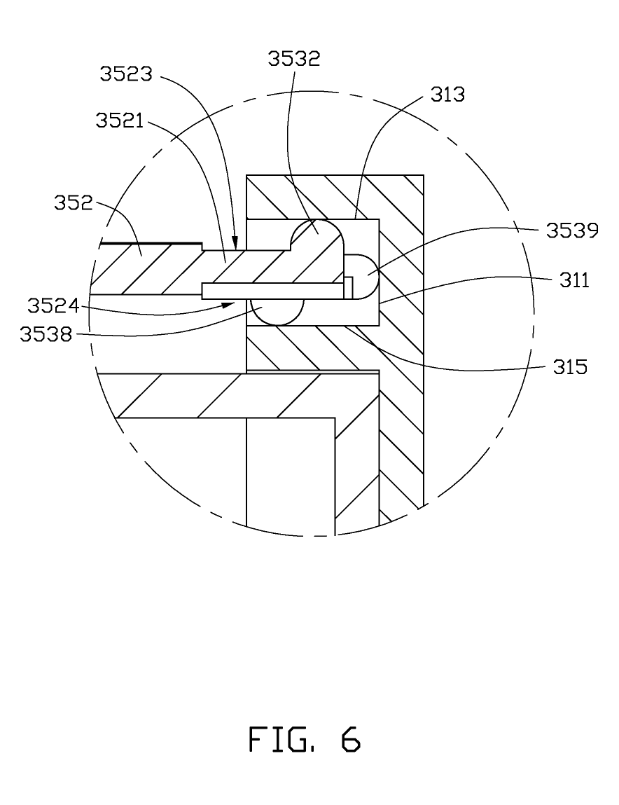

FIG. 6 illustrates that the first extending portion 352 include a first surface 3523 and a second surface 3524. The first surface 3523 and second surface 3524 can be substantially perpendicular to the first side end 3511 (as shown in FIG. 2) of the roller shutter body and the first extending portion first surface 3523 can be opposite to and substantially parallel with the first extending portion second surface 3524.

The first extending portion 352 can be substantially same as the first extending portion 353, and include a first contact portion 3532, a second contact portion 3538, and a third contact portion 3539.

The first contact portion 3532 can protrude from the first extending portion first surface 3523 and positioned at one end of the first extending arm 3531 away from the sliding body 351. The second contact portion 3538 can protrude from the first extending portion second surface 3524.

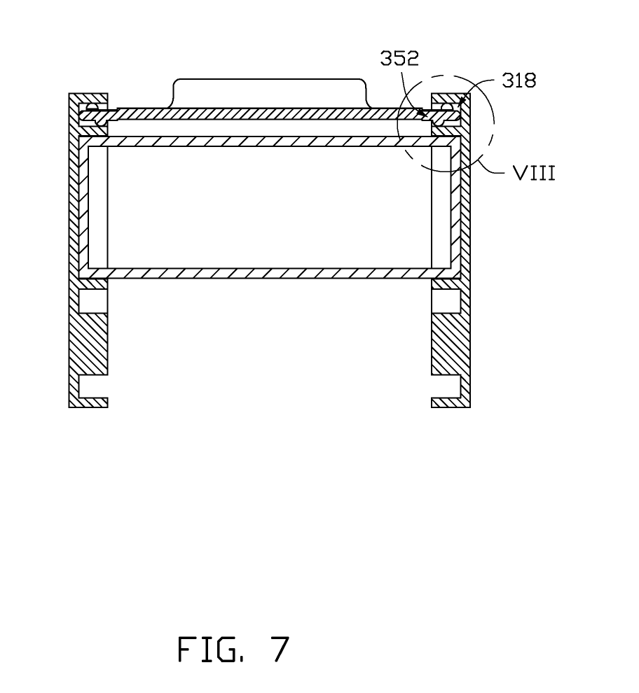

FIG. 7 illustrates that the first extending portion 352 can be slidably received in, and distanced from the first sliding path 318.

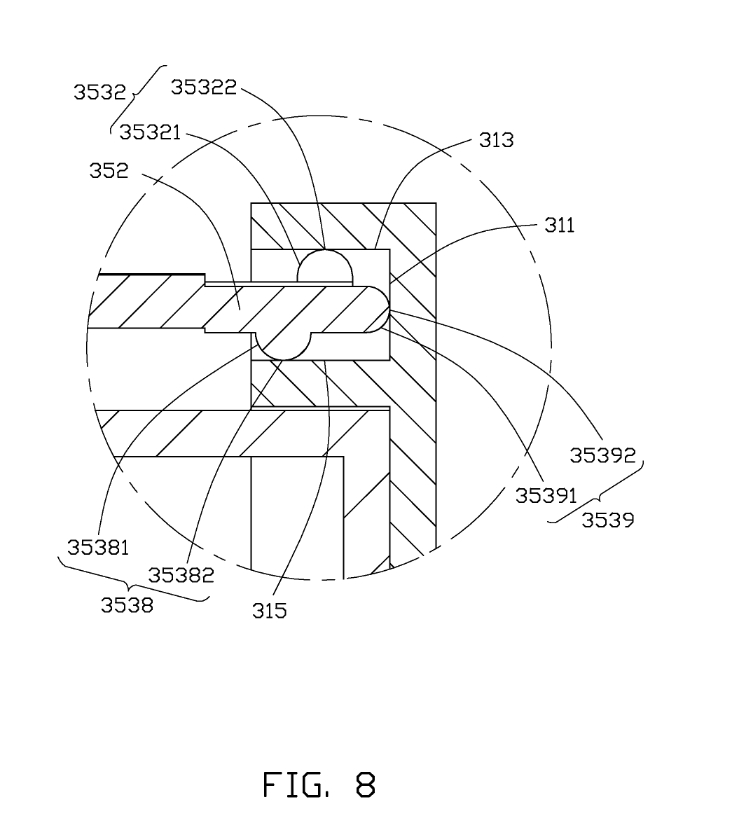

FIG. 8 illustrates that the second contact portion 3538 can be formed on one surface of the base 3536 toward the second supporting wall 315, and the third contact portion 3539 can be formed on one surface of the base 3536 toward the supporting body 311.

The first contact portion 3532 can include a first arc-shaped surface 35321 with a first vertex 35322. The second contact portion 3538 can include a second arc-shaped surface 35381 with a second vertex 35382. The third contact portion 3539 can include a third arc-shaped surface 35391 with a third vertex 35392.

The first vertex 35322 of the first contact portion 3532 can elastically resist against the first supporting wall 313. The second vertex 35382 of the second contact portion 3538 can elastically resist against the second supporting wall 315, and the third vertex 35392 of the third contact portion 3539 can elastically resist against the supporting body 311.

As the first contact portion 3532, the second contact portion 3538, and the third contact portion 3539 can resist against the first sliding path 318 and the second sliding path 338, the extending portions 353 can be supported by the first sliding path 318 and the second sliding path 338 via multi-points contact, and the roller shutter 35 can be positioned between the first supporting member 31 and the second supporting member 33.

In assembling, the container 10 can be interposed between the first supporting member 31 and the second supporting member 33, and the first extending portions 352 and the second extending portions 353 of the roller shutter 35 can be stretched into the corresponding sliding path.

When taking or putting objects, the holding portion 3515 can be pulled, and the roller shutter 35 can slide in the first sliding path 318 and the second sliding path 338 to open or close the opening 153. At this time, the first extending portions 352 and the second extending portions 353 can slide along the first sliding path 318 and the second sliding path 338 by the first contact portions 3532, the second contact portions 3538, and the third contact portions 3539.

The roller shutter type box 100 can include the first extending portions 352 and the extending portions 353, and the first contact portion 3532, the second contact portion 3538, and the third contact portion 3539 can form point contacts with the first supporting wall 313, the second supporting wall 315, and the supporting body 311. Therefore, the first extending portions 352 and the second extending portions 353 can be stably received in the first sliding path 318 and the second sliding path 338, and the friction resistance can be smaller than the conventional roller shutter type box. Furthermore, the sliding body 351 can define the plurality of grooves 3513 extending from the first supporting member 31 toward the second supporting member 33, thus the roller shutter 351 can bend to match to the first sliding path 318. The roller shutter type box 100 can have a simple structure, and the sliding body 351 can be integrally formed with the extending portions 353 to save production cost.

In other embodiments, the second supporting member 33 can be omitted, and a plurality of first extending portions 352 can protrude out of one side of the sliding body 351 and slidably received in the sliding path 318 of the first supporting member 33.

In other embodiments, the first sliding path 318 can be a vignoles rail, and the extending portions 353 can define slide grooves to receive the vignoles rail. The first contact portion 3532 can protrude out of one surface of the slide groove of the first extending arm 3531 toward the vignoles rail, the second contact portion 3538 can protrude out of one surface of the slide groove of the second extending arm 3535 toward the vignoles rail, and the third contact portion 3539 can protrude out of the bottom of the slide groove of the second extending arm 3535. The vertexes of first contact portion 3532, the second contact portion 3538 can resist against a top and a bottom ends of the vignoles rail, and the vertex of the third contact portion 3539 can resist against the vignoles rail toward the end surface of the slide groove.

In other embodiments, the second extending arm 3535 can be omitted, and the second contact portion 3538 and the third contact portion 3539 can be formed at the first extending arm 3531, as long as the first contact portion 3532, the second contact portion 3538, and the third contact portion 3539 can be in point contact with the first supporting wall 313, the second supporting wall 315, and the supporting body 311.

In other embodiments, the first contact portion 3532, the second contact portion 3538, and the third contact portion 3539 can be other curved structure, as long as the vertex of the curved structure can be in point contact with the first sliding path 318.

In other embodiments, the groove 3513 can be omitted, and the sliding body 351 can be made of an elastic material which can bend.

The embodiments shown and described above are only examples. Many details are often found in the art such as the other features of a guide rail structure and a roller shutter type box. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A guide rail and roller shutter structure comprising:
a first supporting member, the first supporting member including a first member first supporting wall and a first member second supporting wall, opposite to and substantially parallel with the first member first supporting wall, with a first sliding path formed there between;
a second supporting member, the second supporting member including a second member first supporting wall and a second member second supporting wall, opposite to and substantially parallel with the second member first supporting wall, with a second sliding path formed there between; and
a roller shutter slidably mounted between the first supporting member and the second supporting member, the roller shutter having a sliding body with a first side end and a second side end and a plurality of first extending portions extending from the first side end of the sliding body and a plurality of second extending portions extending from the second side end of the sliding body;
wherein, the plurality of first extending portions is received into the first sliding path and the plurality of second extending portions is received into the second sliding path;
wherein, each of the plurality of first extending portions have a first surface and a second surface, the first surface and second surface being substantially perpendicular to the first side end of the roller shutter body and the first extending portion first surface being opposite to and substantially parallel with the first extending portion second surface;
wherein, each of the plurality of second extending portions have a first surface and a second surface, the first surface and second surface being substantially perpendicular to the second side end of the roller shutter body and the second extending portion first surface being opposite to and substantially parallel with the second extending portion second surface;
wherein, a first contact portion protrudes from each of the first extending portion first surfaces and each of the second extending portion first surfaces and a second contact portion protrudes from each of the first extending portion second surfaces and each of the second extending portion second surfaces; and
wherein, the first contact portions and second contact portions slidably contact the first supporting wall and second supporting wall of the first supporting member and the second supporting member allowing the roller shutter to slide along the first and second sliding paths.

2. The guide rail and roller shutter structure as claimed in claim 1, wherein each of the plurality of the first contact portion and the second contact portion comprises an arc-shaped surface with a vertex, and the vertexes of the first contact portions and the second contact portions slidably contact the first supporting wall and second supporting wall of the first supporting member and the second supporting member.

3. The guide rail and roller shutter structure as claimed in claim 1, wherein,
the first supporting member further comprises a first member supporting body, and the first member first supporting wall and the second member second supporting wall are positioned on the first member first supporting body; and
the second supporting member further comprises a second member supporting body, and the second member first supporting wall and the second member second supporting wall are positioned on the second member second supporting body.

4. The guide rail and roller shutter structure as claimed in claim 3, wherein,
each of the first extending portions and the second extending portions further comprises a third contact portion protruding out of one end of the first extending portion and the second extending portion away from the sliding body; and
the third contact portion comprises an arc-shaped surface with a vertex, and the vertex of the third contact portion slidably contact the supporting body of the first supporting member and the second supporting member.

5. The guide rail and roller shutter structure as claimed in claim 4, wherein,
each of the first extending portions and the second extending portions comprises a first extending arm and a second extending arm positioned adjacent to and distanced from each other;
the first contact portion protrudes out of a surface of the first extending arm toward the first supporting wall; and
the second contact portion protrudes out of a surface of the second extending arm toward the second supporting wall, and the third contact portion protrudes out of one end of the second extending arm toward the supporting body.

6. The guide rail and roller shutter structure as claimed in claim 5, wherein one end of the first extending arm away from the sliding body is spaced from the supporting body, and one surface of first extending arm away from the first contact portion is spaced from the second supporting wall.

7. The guide rail and roller shutter structure as claimed in claim 5, wherein one surface of the second extending arm away from the second contact portion comprises a convex shaft; the convex shaft is distanced from the first supporting wall, and extends from the sliding body toward the supporting body.

8. The guide rail and roller shutter structure as claimed in claim 1, wherein the first contact portion and the second contact portion are substantially hemispheric.

9. The guide rail and roller shutter structure as claimed in claim 1, wherein,
a surface of the sliding body defines a plurality of strip grooves, and the sliding body is divided into a plurality of connecting portions by the strip grooves;
the connecting portions are connected sequentially, and each connecting portion extends along a direction substantially perpendicular to the first sliding path; and
each extending portion is positioned at one end of the corresponding connecting portion.

10. A roller shutter type box comprising:
a container having an opening; and
a guide rail and roller shutter structure positioned on the container, the guide rail and roller shutter structure including:
a first supporting member, the first supporting member including a first member first supporting wall and a first member second supporting wall, opposite to and substantially parallel with the first member first supporting wall, with a first sliding path formed there between;
a second supporting member, the second supporting member including a second member first supporting wall and a second member second supporting wall, opposite to and substantially parallel with the second member first supporting wall, with a second sliding path formed there between; and
a roller shutter slidably mounted between the first supporting member and the second supporting member, the roller shutter having a sliding body with a first side end and a second side end and a plurality of first extending portions extending from the first side end of the sliding body and a plurality of second extending portions extending from the second side end of the sliding body;
wherein, the plurality of first extending portions is received into the first sliding path and the plurality of second extending portions is received into the second sliding path;
wherein, each of the plurality of first extending portions have a first surface and a second surface, the first surface and second surface being substantially perpendicular to the first side end of the roller shutter body and the first extending portion first surface being opposite to and substantially parallel with the first extending portion second surface;
wherein, each of the plurality of second extending portions have a first surface and a second surface, the first surface and second surface being substantially perpendicular to the second side end of the roller shutter body and the second extending portion first surface being opposite to and substantially parallel with the second extending portion second surface;
wherein, a first contact portion protrudes from each of the first extending portion first surfaces and each of the second extending portion first surfaces and a second contact portion protrudes from each of the first extending portion second surfaces and each of the second extending portion second surfaces; and
wherein, the first contact portions and second contact portions slidably contact the first supporting wall and second supporting wall of the first supporting member and the second supporting member allowing the roller shutter to slide along the first and second sliding paths.

11. The roller shutter type box as claimed in claim 10, wherein each of the plurality of the first contact portion and the second contact portion comprises an arc-shaped surface with a vertex, and the vertexes of the first contact portions and the second contact portions slidably contact the first supporting wall and second supporting wall of the first supporting member and the second supporting member.

12. The roller shutter type box as claimed in claim 10, wherein,
the first supporting member further comprises a first member supporting body, and the first member first supporting wall and the second member second supporting wall are positioned on the first member first supporting body; and
the second supporting member further comprises a second member supporting body, and the second member first supporting wall and the second member second supporting wall are positioned on the second member second supporting body.

13. The roller shutter type box as claimed in claim 12, wherein,
each of the first extending portions and the second extending portions further comprises a third contact portion protruding out of one end of the first extending portion and the second extending portion away from the sliding body; and
the third contact portion comprises an arc-shaped surface with a vertex, and the vertex of the third contact portion slidably contact the supporting body of the first supporting member and the second supporting member.

14. The roller shutter type box as claimed in claim 13, wherein,
each of the first extending portions and the second extending portions comprises a first extending arm and a second extending arm positioned adjacent to and distanced from each other;
the first contact portion protrudes out of a surface of the first extending arm toward the first supporting wall; and
the second contact portion protrudes out of a surface of the second extending arm toward the second supporting wall, and the third contact portion protrudes out of one end of the second extending arm toward the supporting body.

15. The roller shutter type box as claimed in claim 14, wherein one end of the first extending arm away from the sliding body is spaced from the supporting body, and one surface of first extending arm away from the first contact portion is spaced from the second supporting wall.

16. The roller shutter type box as claimed in claim 14, wherein one surface of the second extending arm away from the second contact portion comprises a convex shaft; the convex shaft is distanced from the first supporting wall, and extends from the sliding body toward the supporting body.

17. The roller shutter type box as claimed in claim 10, wherein the first contact portion and the second contact portion are substantially hemispheric.

18. The roller shutter type box as claimed in claim 10, wherein,
a surface of the sliding body defines a plurality of strip grooves, and the sliding body is divided into a plurality of connecting portions by the strip grooves;
the connecting portions are connected sequentially, and each connecting portion extends along a direction substantially perpendicular to the first sliding path; and
each extending portion is positioned at one end of the corresponding connecting portion.
